(19) United States
(12) Patent Application Publication
(10) Pub. No.: US 2002/0163270 A1
(43) Pub. Date: Nov. 7, 2002

(54) Permanent magnet electric motor

(76) Inventor: Enrique Almada, Obernau (CH)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/137,770

(22) Filed: May 2, 2002

(30) Foreign Application Priority Data
May 4, 2001 (EP) 01810440.6

(51) Int. Cl. H02K 21/12

(52) U.S. Cl. 310/156.47

(57) ABSTRACT

A permanent magnet electric motor for use in an elevator installation includes a stator and a rotor assembly. The rotor assembly has a frame on which are mounted at least two rings with permanent magnets. The rings are removably mounted and are laterally fixed together by a fastener that also radially aligns the rings. The number of similar rings used defines a rotor length in multiple values of the ring length. The rings can be shifted by a suitable magnetic angle to permit the generation of a skewing effect of the magnets which reduces or eliminates a cogging torque of the motor. The rotor assembly can be easily and quickly installed and/or removed in very small spaces, especially in elevator installations.

### BACKGROUND OF THE INVENTION

The present invention relates to a permanent magnet electric driving machine, especially for elevator installations.

The U.S. Pat. No. 5,898,990 to Henry shows a method for assembling one or more unitary permanent magnet rings on a rotor body for an electric motor or generator when the rotor has a greater coefficient of thermal expansion than the rings. This method includes the steps of forming grooves in the cylindrical surface of the rotor, applying a curable adhesive on the surface and placing the unitary permanent magnet rings over the adhesive bearing cylindrical surface. The unitary magnet rings have a magnetic orientation in the radial direction.

The U.S. Pat. No. 5,998,902 to Sleder, Sr. et al. is related to a magnet rotor assembly comprising a plurality of permanent magnets embedded within a nonmagnetic ring and having several locking protrusions which can be caused to elastically deflect in a radially inward direction. When the locking protrusions rebound elastically into a groove, the ring is locked permanently into a rotatable component and cannot be removed without deforming and seriously damaging the ring. The locking protrusions can extend circumferentially around the outer periphery of the ring.

The U.S. Pat. No. 4,877,986 to Shimizu relates to a rotor of a magnetic generator comprising a plurality of magnets disposed on an inner surface of a peripheral wall of a flywheel at intervals of a predetermined angle, and having a magnet-holding cylinder with an outward flange and a plurality of outward protrusions, wherein the magnets are positioned thereby to be parallel to the axis of the magnet-holding cylinder.

The conventional construction of the motors of the above-described type consists of fixing the magnets either directly on the surface of a rotor frame or on a lamination sheet package.

Drawbacks of the motors according to the state of the art are that the configuration of the magnet holding bodies is quite complicated, and that special machine tools are required to install the magnets, which will increase the cost of production.

### SUMMARY OF THE INVENTION

The present invention concerns an apparatus that provides an improved electric machine, preferable a synchronous machine or motor, used for elevator installations.

One of the advantages of the motor according to the invention, is that the rotor of such machine can be easily and quickly installed and/or removed in very small spaces, especially elevator installations.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a schematic elevation view of a steel ring having permanent magnets installed thereon;

FIG. 2 is a perspective view of a rotor having four steel rings with permanent magnets as shown in FIG. 1 according to a preferred embodiment of the invention;

FIG. 3 is a perspective view of a stator assembled with the rotor shown in FIG. 2;

FIG. 4 is a schematic illustration of a preferred embodiment of an elevator driving machine according to the present invention; and

FIG. 5 is an elevation view of a stator assembled with a rotor according to an alternate embodiment of the present invention.

### DESCRIPTION OF THE PREFERRED EMBODIMENT

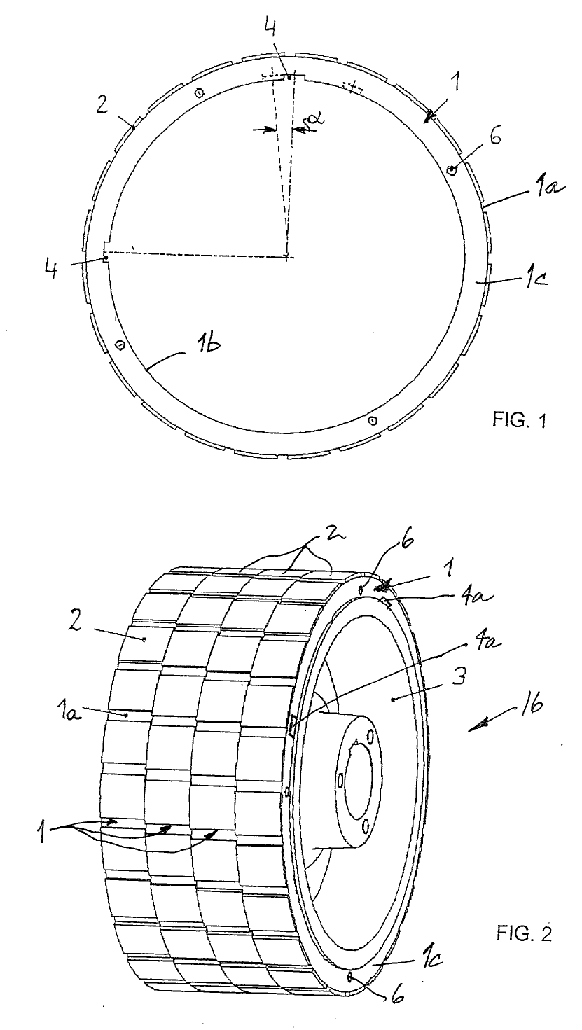

As seen in FIGS. 1 and 2, a permanent magnet electric motor inductor or rotor assembly 16 according to a preferred embodiment of the present invention comprises four steel rings 1 each having a plurality of permanent magnets 2 fixed on an outer peripheral surface 1a of the ring. As shown in FIG. 2, the assembled rotor 16 includes four of the steel rings 1 with the magnets 2 mounted adjacent one another on a generally cylindrical rotor frame 3. However, although four of the rings 1 are shown, the rotor assembly can use two, three or more than four such rings. The rings 1 are formed of steel or another suitable ferromagnetic material and have the same diameter. An inner surface 1b of each of the rings 1 is slidably mounted on an outer surface of the rotor frame 3. The inner surface 1b of the ring 1 has at least one axially extending slot 4 formed therein which slot serves as an alignment means and to fix the rings on the rotor 3, e. g. with the help of a locking means 4a such as gussets, plates or brackets (FIGS. 2 and 3). For example, the locking means 4a can be a wedge that is pressed into the slot 4 and frictionally engages the outer surface of the rotor frame 3. Another form of the locking means 4a can be a flange radially extending from the outer surface of the rotor frame 3. The same or similar rings 1 can be employed for motors of different iron lengths, defining standard iron lengths as multiple values of the ring length (longitudinal width of the ring).

As illustrated in FIG. 3, the magnet rings 1 can be removed from the rotor 3 by the use of threaded ties 5 which can be inserted into respective holes 6 formed in an end surface 1c of the rings. In this case, the ties 5 are very simple tools for the successive removal of the rings 1 in cooperation with the holes 6. It is also possible to use the ties 5 to reinforce the fixation of the rings together in the axial direction if the holes in adjacent rings are aligned. This is possible, but not absolutely necessary because the fixation is achieved by cooperation of the slot 4 and the locking means 4a (gussets, plates, brackets or the like) which are very efficient to resist especially tangential forces.

As shown in FIG. 1, the rings 1 may be radially offset by an arbitrary magnetic shifting angle α. This permits the generation of a skewing effect of the magnets 2 which reduces or eliminates the cogging torque of the motor. If the magnets 2 of two adjacent rings 1 are positioned in the same overlapping manner as depicted in FIG. 2, the slot 4 of the second one of the rings is shifted by the angle a relative to the slot 4 of the first ring as shown in dashed line. However, when assembling the rings 1, the magnets 2 of the second ring must be revolved around the central axis before being fixed to the outer surface 1a, i. e. shifted counterclockwise with the angle a in order to have the slots 4 of both the first and second rings in a straight line, so that the fixing or locking means 4a can be introduced into the slots of the rings. The same is true for each subsequent ring 1 mounted on the rotor 3. As a result, the slots 4 will be aligned in the manner shown in FIG. 3 and the magnets 2 will be offset by the angle a, preferably with the offset angle in a range of 0°<α<3°.

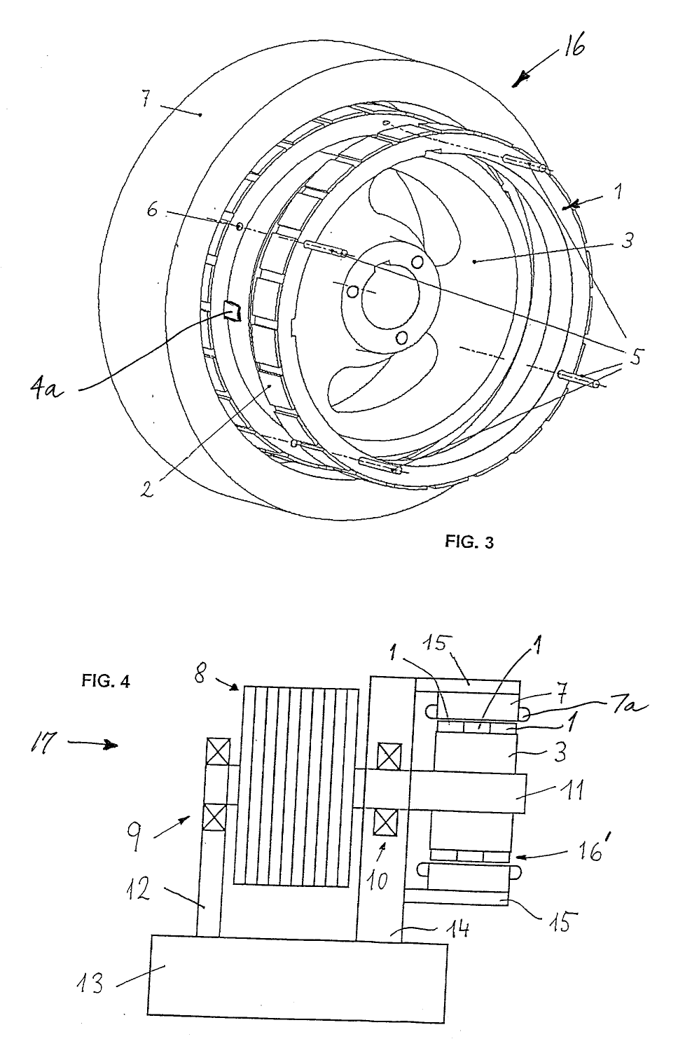

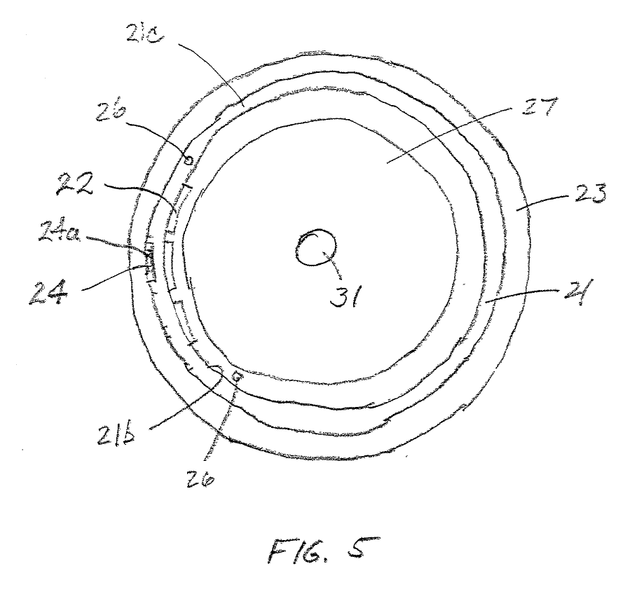

FIG. 3 shows a portion of a permanent magnet motor having an air gap between the magnets 2 of the rotor assembly 16 and an inner surface of a tubular stator 7 encircling the rotor assembly. Naturally, the stator 7 includes a stator coil 7a (FIG. 4). In a preferred embodiment of the invention, the circular rim or edge 1cof the steel ring 1 has a sufficiently large thickness to receive the long holes 6 for the threaded ties 5 or other removing elements or tools. The holes 6 extend parallel to the axis of rotation of the ring 1, i.e. perpendicular to a plane of the edge 1c of the ring. The stator coil 7a is provided with alternating current power for synchronous motor operation.

An elevator driving machine 17 according to FIG. 4 includes a driving wheel or sheave 8, preferably intended to coil up a suspension rope (not shown) of an elevator installation. The driving wheel 8 is located between two bearings 9 and 10 and is mounted on an axle 11 rotatably retained by the bearings. The rotor frame 3 is fixed to the axle 11 on the opposite side of the bearing from the wheel 8. The bearing 9 can be attached to a support 12 fixed to a base 13 located in the machine room (not shown) of the elevator installation. The driving machine 17 can include a stator frame 14 supporting the bearing 10 and, with the help of connection means 15, also supporting the stator 7. As seen in FIG. 4, the rotor frame 3 and the stator 7 can be mounted spaced from the bearing 10 supporting the rotor frame. This unilateral embodiment having the rotor frame 3 exterior to the bearing 10 on a free end of the axle 11 facilitates the easy and quick installation of two or more of the rings 1 with the permanent magnets 2, e. g. three of the rings 1 are provided to form an inductor or rotor assembly 16′ similar to the inductor or rotor assembly 16 shown in FIGS. 2 and 3.

A method for assembling a permanent magnet electric machine with an armature 7, and a rotor frame 3 with two or more of the rings 1 having the magnets 2, can comprise the following method steps:

a. providing a base 13 with a support 12 having a first bearing 9 and a stator frame 14 having a second bearing 10;

b. mounting the stator 7 on the stator frame 14 with the connection means 15;

c. mounting the rotor frame 3 on the axle 11 and rotatably supporting the axle in the bearings; and

d. removably mounting on the rotor frame 3 a first one of the rings 1 having the magnets 2, removably mounting on the rotor frame 3 a second one of the rings 1 having the magnets 2, fixing the second ring adjacent the first ring with the magnets of the same polarity in a predetermined alignment with the help of the alignment means 4 and the locking means 4a, and removably mounting and fixing successively any other rings.

For this purpose, it is also possible but not absolutely necessary to have several slots in each ring, e.g. “n−1” slots for a number “n” of rings. For convenience, the stator 7 and/or the rotor frame 3 can be provided with shoulders (not shown) for supporting the ends of a very simple tool, preferably in the form of a jack, lifting jack, screwing jack, etc., to facilitate the introduction of the rings 1 onto the rotor frame.

One advantage of this method of construction is that during the phase of mounting the magnets 2, it is easier to assemble small magnets on the surface of the steel ring 1 than assemble big magnets on the surface of a rotor. It is also easier to handle single magnet rings 1 than an entire rotor. In addition to this, the rings 1 can be produced separately, and they can be formed e. g. from standard iron tubes.

Another advantage of the method according to the present invention results of the fact that, for robustness reasons, it would be convenient that the length of the magnets 2 do not exceed certain dimensions, typically 50 mm, because otherwise they become fragile. Preferably, surface of the magnet 2 facing the stator 7 can be in a range of 10 to 100 cm² in area. The magnet plates 2 do not necessarily need to be curved to conform to the curvature of the rotor frame 3 and the stator 7 as is shown. According to the present invention it is not required to position two or more of the magnets 2 of the same polarity close to each other, as in the normal construction, thereby avoiding a complex operation due to the forces between the magnets and any requirement for special tools. The magnetic elements 2 can be flat elements, e.g. rare earth permanent magnets, such as neodymium-iron-boron (NdFeB), cobalt, samarium or cheap hard permanent ferrite magnets disposed with alternating magnetic polarities. Preferably, the rings 1 are formed from a soft magnetic material such as mild steel, preferably having a relative high permeability μ>>1. The magnets 2 can be glued to the rings 1.

Another advantage of this method according to the present invention relates to the steps of disassembling the motor. For large machines located in very small spaces, when it is necessary to remove the rotor assembly in case of failure of the stator 7 without transporting the motor, for example in large elevator installations, the rings 1 can be removed successively one at a time by inserting the threaded ties 5 into the respective holes 6. For convenience, the holes 6 also can be shifted in the different rings 1. Once the rings 1 are removed, the frame 3 of the rotor can be easily removed because there are no magnetic forces between the rotor frame and the stator 7, and special devices to guide the rotor out of the stator, as required for conventional permanent magnet motor constructions, are not needed.

Another advantage of this method is that the undesirable parasite cogging torque or ripple torque can be avoided or compensated. This effect arises from the interaction between the magnets 2 and the teeth of the stator 7, which are normally straight. According to the present invention, the feature of separating the magnets 2 in several straight pieces allows obtaining a skewing effect by shifting the adjacent rings 1 with the angle α in order to compensate the parasite torque.

The above-described type of motor is of the interior-rotor machine type because the magnets 2 are fixed on the outer surface 1a of the ring 1 on the rotor frame 3. According to another embodiment of the present invention shown in FIG. 5, a plurality of magnets 22 can be fixed on an inner surface 21b of a ring 21 to provide an exterior-rotor machine type. In this case, a stator 27 is positioned inside the rings 21 that are mounted inside a tubular rotor frame 23. The rings 21 are provided with slots 24 cooperating with locking means 24a to locate the rings in the rotor 23 and are provided with holes 26 for cooperation with the ties 5 for removing the rings. More generally speaking, the rotor 23 with the magnets 22 can be an inductor and the stator 27 with the coils can be an armature. Normally the armature (stator 27) is fixed to a plate or base and does not move. However, there are types of machines, in which the inductor (rotor 23) does not move and the armature 27 is mounted on an axle 31 so as to revolve inside of the inductor. Typically, the rotor may be designed for a rotational speed in a range of 30 to 900 rpm.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A permanent magnet electric machine comprising:
an armature; and
an inductor having at least two rings with a plurality of permanent magnets fixed on one of an outer surface and an inner surface of each of said rings, said inductor having a frame with said rings being removably mounted on said frame and said rings being laterally fastened together by a locking means.

2. The machine according to claim 1 wherein said frame has a generally cylindrical shape and said rings are mounted on an outer surface of said frame, said magnets being fixed on said outer surface of said rings.

3. The machine according to claim 1 wherein said frame has a generally tubular shape and said rings are mounted on an inner surface of said frame, said magnets being fixed on said inner surface of said rings.

4. The machine according to claim 1 wherein each said ring has at least one slot formed therein cooperating with said locking means to fix said rings on said frame.

5. The machine according to claim 1 wherein said rings have a predetermined axial width and a length of said frame determines a maximum integral number of said rings mounted on said frame.

6. The machine according to claim 1 wherein said rings are provided with disassembling means for successively removing said rings from said frame by use of at least one cooperating disassembling tool.

7. The machine according to claim 1 wherein said rings are angularly shifted relative to one another by a magnet shifting angle to permit the generation of a skewing effect of said magnets to reduce a cogging torque of the machine.

8. The machine according to claim 1 wherein said magnets are shaped as plates in a range of 10 to 100 cm² in area, preferably curved according to a curvature of a facing surface of said armature.

9. A permanent magnet electric driving machine for an elevator installation comprising:
an armature having windings;
an inductor assembly having a frame with at least two rings with permanent magnets mounted thereon; and
a fastening means removably fixing said rings on said frame whereby said armature and said inductor assembly are mounted to rotate relative to one another to operate as a synchronous electric motor.

10. The machine according to claim 9 including a rotatably supported axle attached to said frame and an elevator driving sheave attached to said axle whereby rotation of said frame rotates said driving sheave.

11. The machine according to claim 9 wherein said frame is attached at a free end of said axle for ease of removal of said rings from said frame.

12. A method for assembling the permanent magnet electric driving machine of claim 9 comprising the steps of:
a. providing the inductor frame;
b. removably mounting on the frame a first one of the rings having magnets;
c. removably mounting on the frame a second one of the rings having magnets;
d. fixing the second ring laterally relative to the first ring with the magnets of the same polarity in a predetermined alignment with the fastening means; and
e. performing said steps c. and d. for any additional ones of the rings having magnets to be removably mounted on the frame.

13. A method for disassembling the inductor assembly of the permanent magnet electric driving machine of claim 9 comprising the steps of:
a. disabling the fastening means;
b. removing each of the rings successively one at a time from the frame; and
c. demounting the frame.
